(19) United States
(12) Patent Application Publication
(10) Pub. No.: US 2014/0329569 A1
(43) Pub. Date: Nov. 6, 2014

(54) PORTABLE WIRELESS DEVICE

(71) Applicants: Hironori Kikuchi, Miyagi (JP); Hideo Nakanishi, Kanagawa (JP); Shingo Sumi, Miyagi (JP); Yoshihiro Kanasaki, Ishikawa (JP); Yuichiro Suzuki, Saitama (JP)

(72) Inventors: Hironori Kikuchi, Miyagi (JP); Hideo Nakanishi, Kanagawa (JP); Shingo Sumi, Miyagi (JP); Yoshihiro Kanasaki, Ishikawa (JP); Yuichiro Suzuki, Saitama (JP)

(73) Assignee: Panasonic Corporation, Osaka (JP)

(21) Appl. No.: 14/116,305

(22) PCT Filed: May 11, 2012
(86) PCT No.: PCT/JP2012/003087

§ 371 Date: Nov. 7, 2013

(30) Foreign Application Priority Data
May 13, 2011 (JP) 2011-108203

(51) Int. Cl. H04B 1/38

(52) U.S. Cl. CPC H04B 1/3838
USPC 455/575.5

(57) ABSTRACT

Provided is a portable wireless device (100) including: a circuit board (130); an input unit wiring pattern (140) comprising a flexible substrate that is separate from the circuit board (130); and an antenna element (160) of which a power feed unit (162) is connected to the substrate edge (130a) of the circuit board (130). A vertical wiring unit (142) is wired perpendicularly to the antenna element (160). A first cutoff circuit (171) is installed between the vertical wiring unit (142) and a horizontal wiring unit (143), and cuts off the wiring at a high frequency. The horizontal wiring unit (143) is connected to the circuit board (130) with a connector (150) disposed in the vicinity of the power feed unit (162) therebetween.

### TECHNICAL FIELD

The present invention relates to a mobile radio apparatus, such as a mobile telephone, and particularly, to a mobile radio apparatus having a bar structure.

### BACKGROUND ART

Mobile radio apparatuses such as mobile telephones have been reduced in size and increasing in functionality. In addition, mobile radio apparatuses including built-in antennas have been developed for improving the designability of the apparatuses.

Moreover, a mobile radio apparatus such as a mobile telephone prevents deterioration of the sensitivity of an antenna by increasing the distance between the antenna and a human body. An SAR (Specific Absorption Rate) value is used for an index indicating electromagnetic wave energy absorbed by human body.

Patent Literature (hereinafter, abbreviated as “PTL”) 1 describes a mobile radio configured to selectively use first and second antenna sections placed in a housing, according to a communication mode being used, and thereby to increase the distance between the antenna and the human body to secure favorable communication.

In a mobile radio apparatus having a bar structure, such as a smart phone, a cellular antenna is usually placed at the bottom portion of the apparatus for reducing SAR or ensuring the implementation volume.

PTL 2 describes a receiver including an antenna that is placed near a wiring pattern and that receives an electric wave. In the apparatus described in PTL 2, an antenna element (loop antenna) is orthogonal to the wiring pattern in order to prevent a magnetic field component from crossing over the aperture plane of the antenna. Reception sensitivity performance is improved by reducing the reception of a noise component emitted from the wiring pattern.

### CITATION LIST

### Patent Literature

PTL 1
Japanese Patent Application Laid-Open No. 2003-163956
PTL 2
Japanese Patent Application Laid-Open No. HEI 7-203514

### SUMMARY OF INVENTION

### Technical Problem

In such a mobile radio apparatus according to the prior art, a cellular antenna is usually placed at a lower end housing portion for reducing SAR or ensuring the implementation volume. Moreover, a configuration using a large screen LCD requires an input part to be placed at the bottom portion. Furthermore, a larger screen display section leads to a reduction in the implementation volume.

As described above, the input part is placed in the vicinity of the antenna element at the lower end of the housing. The signal lines of the input part placed near the antenna element leads to a problem of deteriorating the antenna performance due to the closely placed conductors.

It is an object of the present invention to provide a mobile radio apparatus including an antenna element at a lower end housing portion and being capable of reducing the influence of an closely placed input part on the antenna performance and also capable of achieving an increase in the implementation volume of the mobile radio apparatus.

### Solution to Problem

A mobile radio apparatus according to an aspect of the present invention includes: a circuit board; an input part wiring pattern that includes a flexible board different from the circuit hoard; and an antenna element that includes an electric supply section connected to an end of the circuit hoard, in which the input part wiring pattern includes: a key surface portion that includes one or more key portions; an orthogonal wiring portion that includes a wiring pattern wired orthogonally with respect to the antenna element from the key surface portion; a horizontal wiring portion that is connected to the orthogonal wiring portion and that is wired horizontally with respect to the antenna element; and a connector that is placed at the horizontal wiring portion near the electric supply section and that connects the horizontal wiring portion and the circuit board.

### Advantageous Effects of Invention

According to the present invention, it is possible to provide a mobile radio apparatus including an antenna element at a lower end housing portion and being capable of reducing the influence of an closely placed input part on the antenna performance and also capable of achieving an increase in the implementation volume of the mobile radio apparatus.

### BRIEF DESCRIPTION OF DRAWINGS

FIG. 1 is a perspective view illustrating an outline configuration of a mobile radio apparatus according to Embodiment 1 of the present invention;

FIG. 2 is a front view illustrating a main portion of configuration elements of the mobile radio apparatus in FIG. 1;

FIG. 3 is a rear view illustrating a main portion of configuration elements of the mobile radio apparatus in FIG. 1;

FIG. 4 is a side view illustrating a main portion of configuration elements of the mobile radio apparatus in FIG. 1;

FIG. 5 is a developed view illustrating a wiring pattern of an input part in the mobile radio apparatus according to Embodiment 1;

FIG. 6 is a block diagram illustrating a configuration of the wiring pattern of the input part in the mobile radio apparatus according to Embodiment 1;

FIG. 7 is a block diagram illustrating a configuration of a key surface portion in the mobile radio apparatus according to Embodiment 1;

FIG. 8 is a perspective view illustrating the relationship of an orthogonal wiring portion and an antenna element in the mobile radio apparatus according to Embodiment 1;

FIG. 9 is a perspective view explaining how an input part in the mobile radio apparatus according to Embodiment 1 is incorporated;

FIG. 10 is a perspective view explaining how a connector is placed in a horizontal wiring portion in the mobile radio apparatus according to Embodiment 1;

FIG. 11 illustrates, as a comparative example, a case where a connector is placed on a side opposite to a side where an electric supply section is placed in the mobile radio apparatus according to Embodiment 1;

FIG. 12 is a perspective view illustrating a configuration of a first isolation circuit and the GND of a circuit board in the mobile radio apparatus according to Embodiment 1;

FIG. 13 is a top view illustrating a key surface portion of a wiring pattern of an input part in a mobile radio apparatus according to Embodiment 2 of the present invention; and

FIG. 14 is a block diagram illustrating a configuration of the key surface portion in the mobile radio apparatus according to Embodiment 2.

### DESCRIPTION OF EMBODIMENTS

Hereinafter, embodiments of the present invention will be explained in detail with reference to the accompanying drawings.

### Embodiment 1

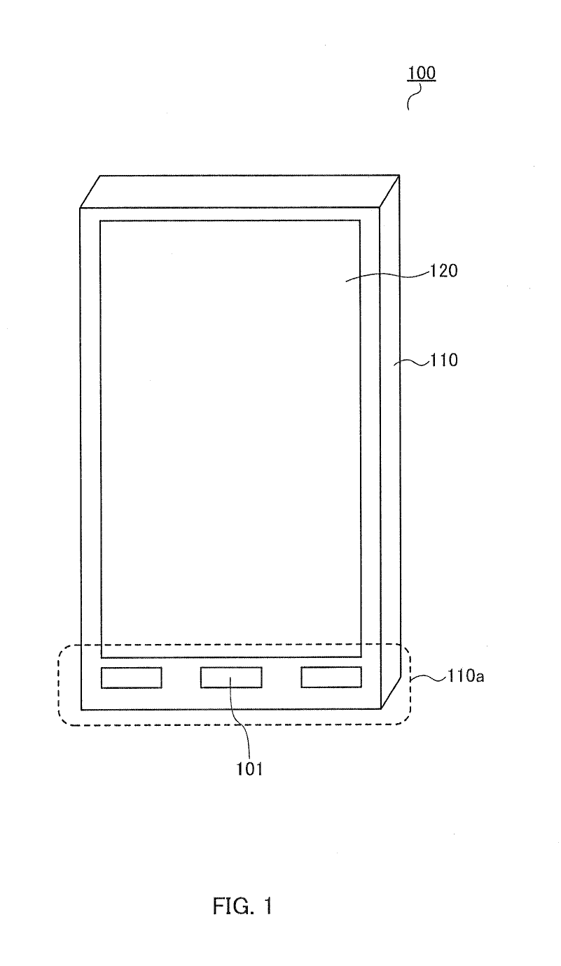

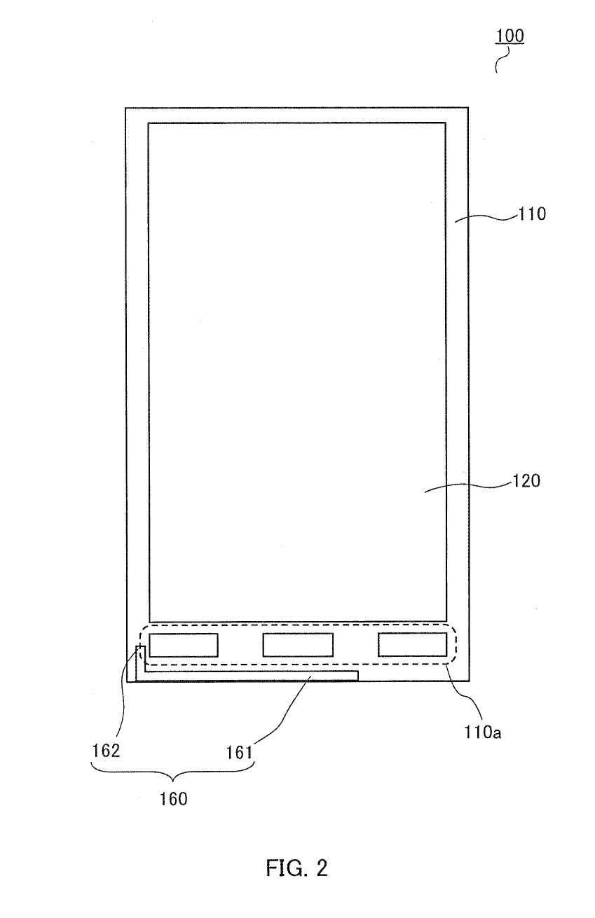

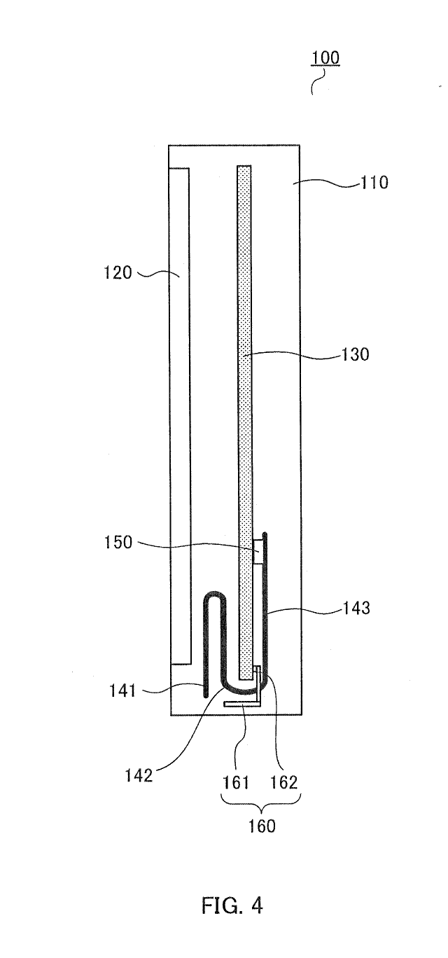

FIG. 1 is a perspective view illustrating an outline configuration of mobile radio apparatus 100 according to Embodiment 1 of the present invention. FIGS. 2, 3, and 4 are front, rear, and side views of a main portion of configuration elements of mobile radio apparatus 100, respectively.

Hereinafter, mobile radio apparatus 100 according to the present invention is embodied with a mobile information terminal such as a PDA (Personal Digital Assistant). Alternatively, application to a camera equipped mobile telephone or a PHS (Personal Handy-Phone System) is also possible.

As illustrated in FIGS. 1 to 4, mobile radio apparatus 100 includes input part 101, housing 110, display section 120, circuit board 130, microphone signal line 140, microphone 150, antenna element 160, shielding pattern 170, and isolation circuit 180.

Input part 101 is mounted at lower end housing portion (bottom portion) 110a of housing 110 below display section 120 and includes functional buttons. Input part 101 is placed at lower end housing portion 110a and is connected to input part wiring pattern 140 to be described below. Display section 120 also has a function of input means, and therefore input part 101 serves as an auxiliary function for input operations and has only few functional buttons and a reduced implementation volume.

Housing 110 has a bar type structure. In the case of folding type mobile radio apparatus 100, housing 110 is a main body side housing

Display section 120 is a large display substantially covering the whole surface of housing 110. Display section 120 includes, for example, an LCD display or an organic electro-luminescence (EL) display and displays, for example, received information and content. A touch panel (not illustrated) is mounted on display section 120. Therefore, display section 120 also has a function of input means. The implementation volume of housing 110 is reduced by the large screen of display section 120.

Circuit board 130 is a printed circuit board on which circuit components realizing various functions of mobile radio apparatus 100 are installed. Board end 130a connected to antenna element 160 and circuit board GND portion 130b, are formed at the lower edge of circuit board 130.

Input part wiring pattern 140 is formed on a flexible board different from circuit board 130. Input part wiring pattern 140 is mounted at lower end housing portion 110a. Input part wiring pattern 140 connects input part 101 (functional buttons) with circuit board 130. Input part wiring pattern 140 is mounted so as to be orthogonal to antenna element 160 described below. A configuration of input part wiring pattern 140 will be described in detail below.

Connector 150 is installed near electric supply section 162. Connector 150 is a board connection section connecting input part wiring pattern 140 with circuit board 130.

Antenna element 160 is mounted at lower end housing portion 110a in the width direction of housing 110. Antenna element 160 is placed orthogonally to horizontal wiring portion 143 of input part wiring pattern 140. Antenna element 160 is connected to board end portion 130a of circuit board 130 through electric supply section 162. Antenna element 160 has electric supply section 162, and conductor portion 161 formed of a metal frame. Electric supply section 162 is connected to board end portion 130a of circuit board 130. The metal frame forming antenna element 160 is formed by using a metal which has high conductivity, a light weight, and high strength such as a magnesium alloy. Conductor portion 161 extends in the width direction of housing 110 in lower end housing portion 110a from electric supply section 162 connected to board end portion 130a. Antenna element 160 is placed near input part wiring pattern 140.

Mobile radio apparatus 100 described above includes: conductor portion 161 of antenna element 160; key surface portion 141; orthogonal wiring portion 142; horizontal wiring portion 143; and connector 150 in this order from lower end housing portion 110a in the upward longitudinal direction of housing 110. In this configuration, key surface portion 141, orthogonal wiring portion 142, and horizontal wiring portion 143 are bent along board end portion 130a. Connector 150 is placed near electric supply section 162 on horizontal wiring portion 143.

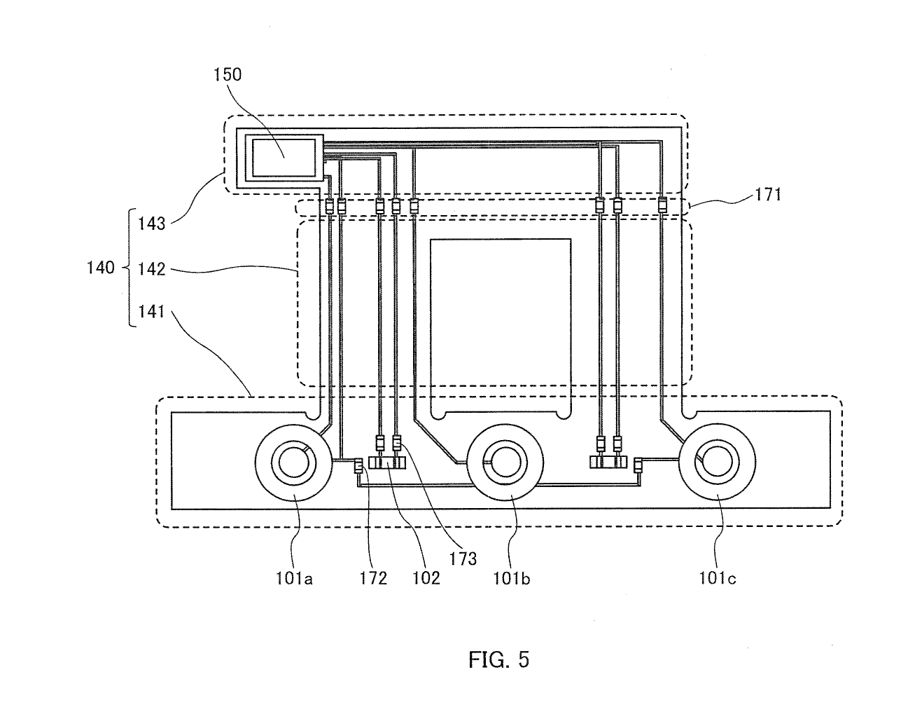

FIG. 5 is a developed view illustrating input part wiring pattern 140.

As illustrated in FIG. 5, input part wiring pattern 140 includes: key surface portion 141 where key portions 101a to 101c, which are depression switches in input part 101 (functional buttons), are installed; orthogonal wiring portion 142 where is wired from key surface portion 141 is made orthogonally to antenna element 160; and horizontal wiring portion 143 where wiring is made to connector 150 from orthogonal wiring portion 142 in parallel to antenna element 160 and circuit board 130.

Key surface portion 141 includes key portions 101a to 101c, LEDs 102, second isolation circuits 172 installed between signal lines having the same potential among key portions 101a to 101c, and third isolation circuits 173 each installed between LED 102 and orthogonal wiring portion 142.

First isolation circuit 171 is installed between orthogonal wiring portion 142 and horizontal wiring portion 143.

Connector 150 connecting input part wiring pattern 140 with circuit board 130 is attached near electric supply section 162 of horizontal wiring portion 143.

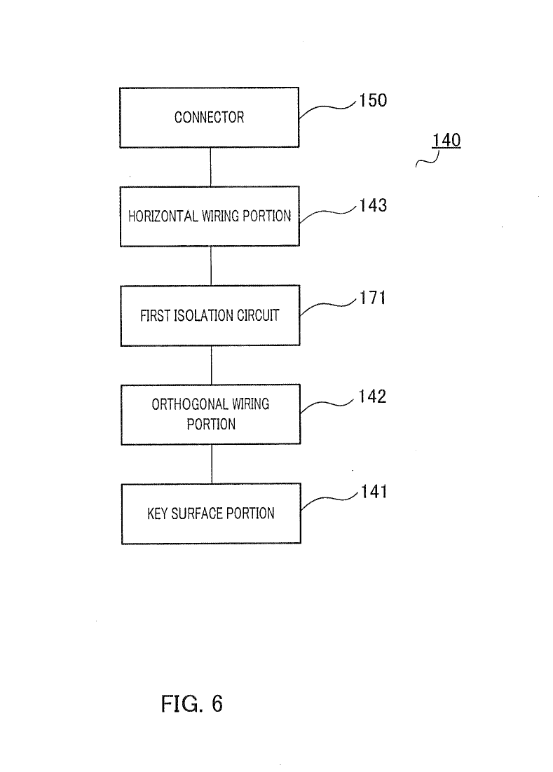

FIG. 6 is a block diagram illustrating a configuration of input part wiring pattern 140.

As illustrated in FIG. 6, input part wiring pattern 140 includes key surface portion 141, orthogonal wiring portion 142, first isolation circuit 171, and horizontal wiring portion 143. Horizontal wiring portion 143 is connected to connector 150 placed near electric supply section 162.

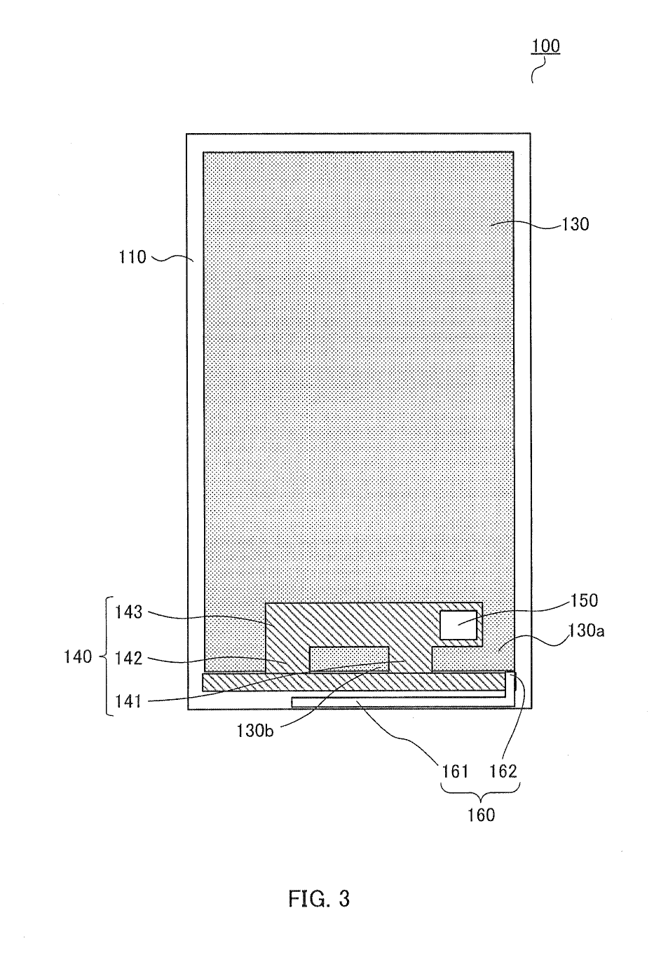

Key surface portion 141 is bent along board end portion 130a (FIG. 3).

Orthogonal wiring portion 142 is wired orthogonally with respect to antenna element 160.

First isolation circuit 171 is installed between orthogonal wiring portion 142 and horizontal wiring portion 143 and isolates the wiring in a high frequency manner.

Horizontal wiring portion 143 is connected to circuit board 130 through connector 150 placed near electric supply section 162.

Hereinafter, a configuration of each part of input part wiring pattern 140 will be explained.

[Key Surface Portion 141]

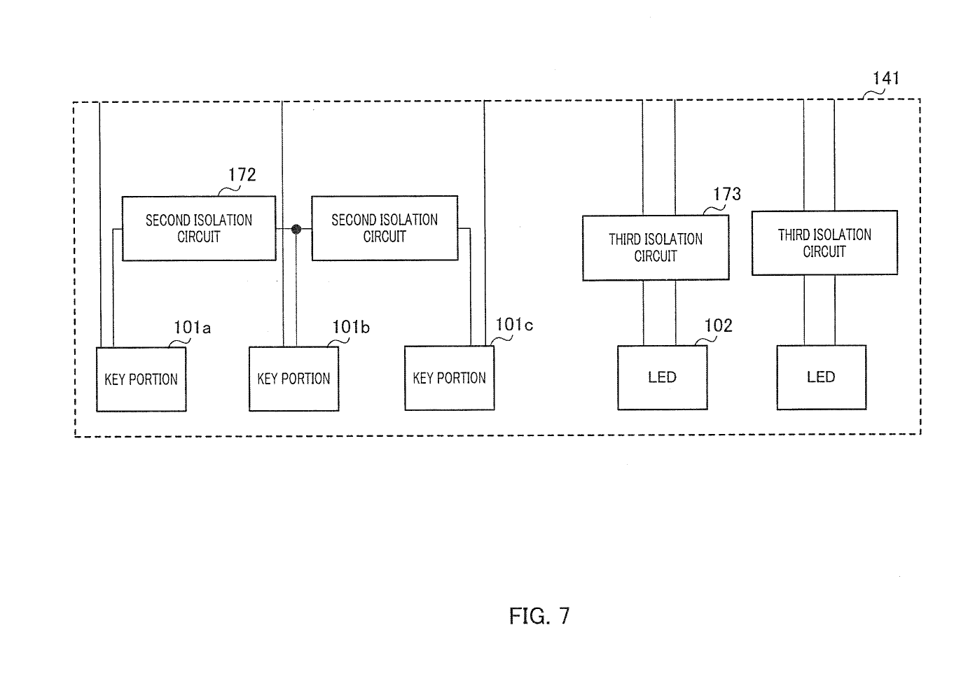

FIG. 7 is a block diagram illustrating a configuration of key surface portion 141. FIG. 7 illustrates an example case where three key portions that are depression switches and two LEDs are provided. Components other than an LED may be mounted on key surface portion 141, and any number of the components may be mounted thereon.

As illustrated in FIG. 7, key surface portion 141 includes key portions 101a to 101c, LEDs 102, second isolation circuits 172 installed between signal lines having the same potential among key portions 101a to 101c, and third isolation circuits 173 each installed between LED 102 and orthogonal wiring portion 142.

On key surface portion 141, the signal lines having the same potential in key portions 101a to 101c on key surface portion 141 are connected through second isolation circuits 172.

LED 102 serving as an example of a component of key surface portion 141 is connected to orthogonal wiring portion 142 through third isolation circuit 173.

In this way, the signal lines having the same potential in key portions 101a to 101c can be connected on key surface portion 141, and mobile radio apparatus 100 can thereby reduce the number of wiring lines in orthogonal wiring portion 142 and reduce the physical width of orthogonal wiring portion 142. As a result, it is made possible to further reduce the influence on the antenna performance and the size of the apparatus.

Moreover, mobile radio apparatus 100 isolates the signal lines from one another in the horizontal direction on key surface portion 141 in a high frequency manner by placing second isolation circuits 172 among key portions 101a to 101c to make the wiring on key surface portion 141 look as if the wiring is not connected in the horizontal direction. This can reduce the wiring while maintaining the configuration of the orthogonal wiring design.

Moreover, the components placed on key surface portion 141 are configured as floating conductors by being separated via second isolation circuits 172 and third isolation circuits 173 in a high frequency manner. This can reduce the influence on the antenna performance due to the closely placed conductors.

Mobile radio apparatus 100 connects LEDs 102 to orthogonal wiring portion 142 through third isolation circuits 173 and can thereby prevent static electricity from damaging LEDs 102.

FIGS. 5 and 6 are only examples of the key surface configuration, and the present invention is not limited to this configuration.

[Orthogonal Wiring Portion 142]

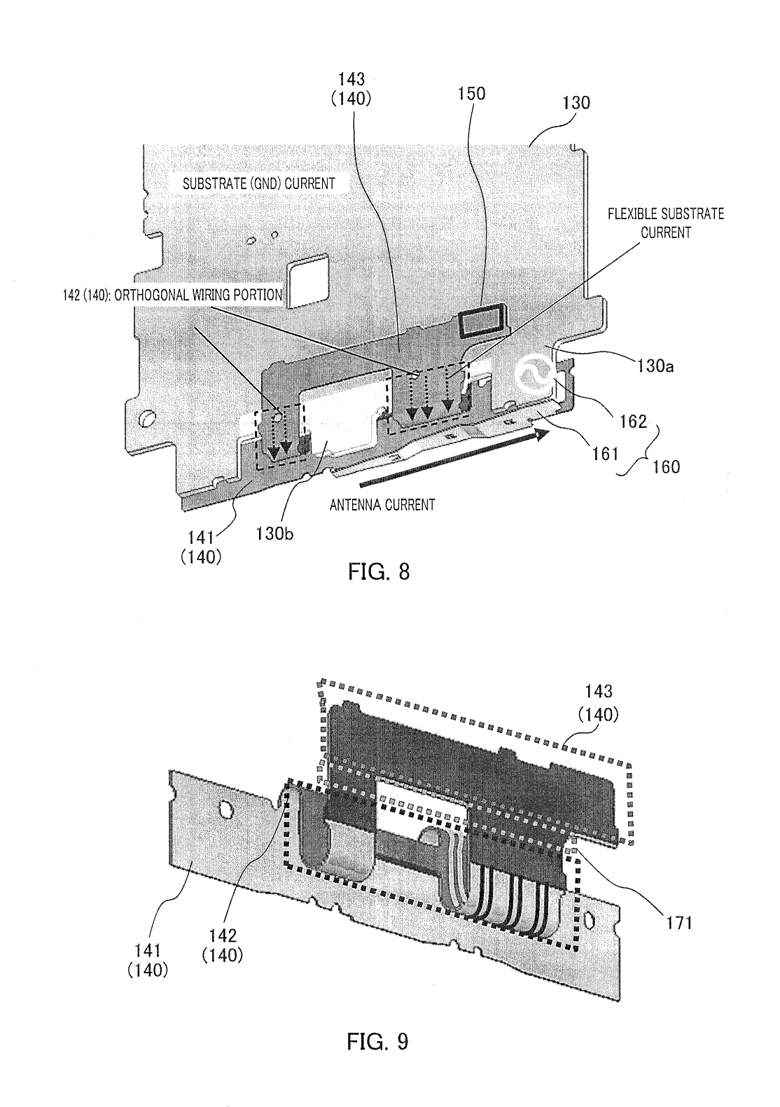

FIG. 8 is a perspective view illustrating the relationship of orthogonal wiring portion 142 and antenna element 160. FIG. 9 is a perspective view explaining how input part 101 is incorporated.

As illustrated in FIG. 8, horizontal wiring portion 143 in input part wiring pattern 140 is connected to circuit board 130 through connector 150 placed near electric supply section 162.

Orthogonal wiring portion 142 in input part wiring pattern 140 is bent at the bottom surface of circuit board 130.

Orthogonal wiring portion 142 adopts a basic configuration in which the orthogonal wiring portion is wired orthogonally with respect to antenna element 160.

Furthermore, as illustrated in FIG. 9, orthogonal wiring portion 142 is configured in such a way that different wiring lines of orthogonal wiring portion 142 do not overlap each other when input part wiring pattern 140, which is formed on a flexible board, is bent. In other words, orthogonal wiring portion 142 is bent in such a way that the bent portions of orthogonal wiring portion 142 face each other. In this configuration, the same wiring lines of orthogonal wiring portion 142 overlap each other while different wiring lines thereof do not overlap each other.

In this way, mobile radio apparatus 100 causes an antenna current (refer to a solid line arrow in FIG. 8) flowing through antenna element 160 to be orthogonal to a flexible board current (refer to dashed line arrows in FIG. 8) flowing through input part wiring pattern 140, and can thereby reduce the influence on the antenna performance.

Moreover, the occurrence of capacitive coupling between wiring lines of orthogonal wiring portion 142 close to antenna element 160 can reduce an increase in the influence on the antenna performance due to orthogonal wiring portion 142.

[Horizontal Wiring Portion 143]

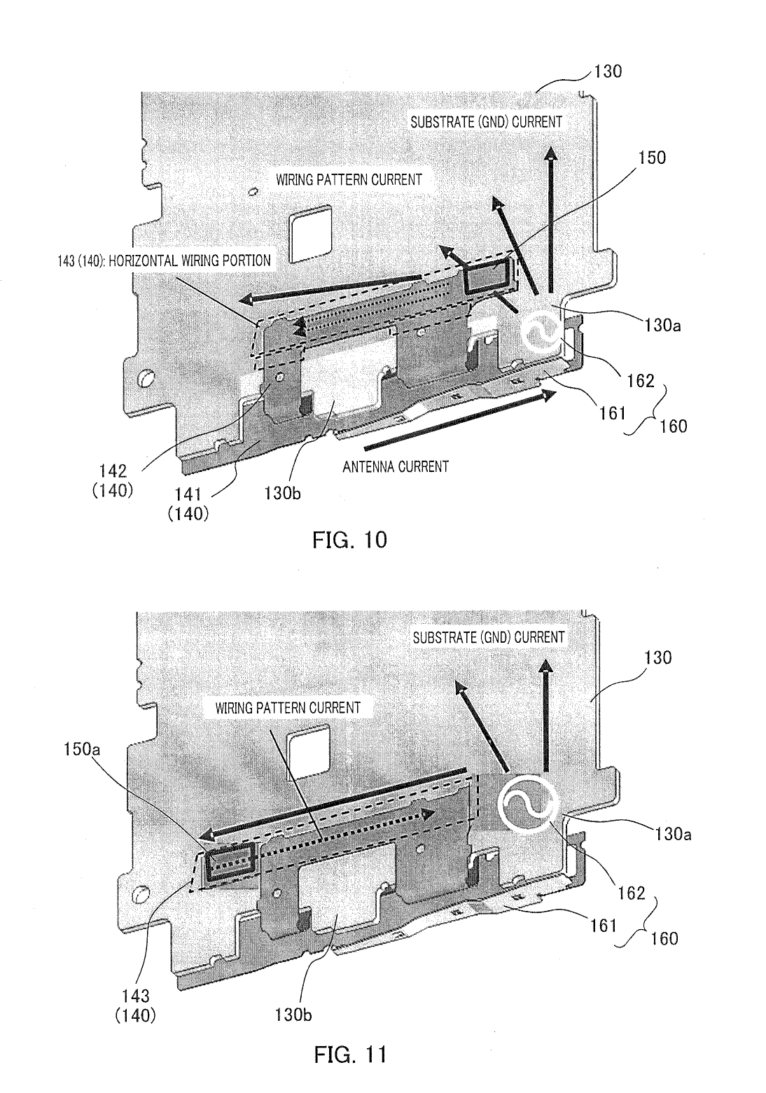

FIGS. 10 and 11 are perspective views explaining how connector 150 is placed in horizontal wiring portion 143. FIG. 10 illustrates a case where conductor 150 is placed on a side where the electric supply section is placed in the present embodiment. FIG. 11 illustrates, as a comparative example, a case where a connector is placed on a side opposite to the side where the electric supply section is placed.

As illustrated in FIG. 10, horizontal wiring portion 143 in input part wiring pattern 140 in the present embodiment is wired horizontally with respect to antenna element 160 and circuit board 130, and is connected to circuit board 130 through connector 150 placed near electric supply section 162.

In this way, mobile radio apparatus 100 causes a hoard (GND) current (refer to a solid line arrow in FIG. 10) flowing through circuit board 130 to have the same phase as a wiring pattern current (refer to a dashed line arrow in FIG. 10) flowing through the wiring pattern of horizontal wiring portion 143 (140), and can thereby reduce the influence on the antenna performance.

As illustrated in the comparative example of FIG. 11, when horizontal wiring portion 143 is connected to a portion of circuit board 130 on a side opposite to a side where the electric supply section is placed, through connector 150a placed on the side opposite to the electric supply section, a board (GND) current (refer to a solid line arrow in FIG. 11) flowing through circuit hoard 130 has an opposite phase to a wiring pattern current (refer to a dashed line arrow in FIG. 11) flowing through the wiring pattern of horizontal wiring portion 143 (140). The influence on the antenna performance cannot be reduced in this case.

In the present embodiment, horizontal wiring portion 143 is wired horizontally with respect to antenna element 160 and circuit board 130 and is connected to circuit board 130 through connector 150 placed on the side where the electric supply section is placed. This configuration causes a board (GND) current flowing through circuit board 130 to have the same phase as a wiring pattern current flowing through the wiring pattern of horizontal wiring portion 143 (140) and thus can reduce the influence on the antenna performance.

In addition to the effect achieved by placing connector 150 on the side the electric supply section is placed, the wiring lines of horizontal wiring portion 143 are bundled by connector 150 in the width direction of circuit board 130, which in turn achieves the following effect.

The wiring of horizontal wiring portion 143 is bundled at the end in the width direction of circuit board 130 and is then connected to circuit board 130 through connector 150, which makes it possible to increase the implementation space of circuit board 130.

[First Isolation Circuit 171]

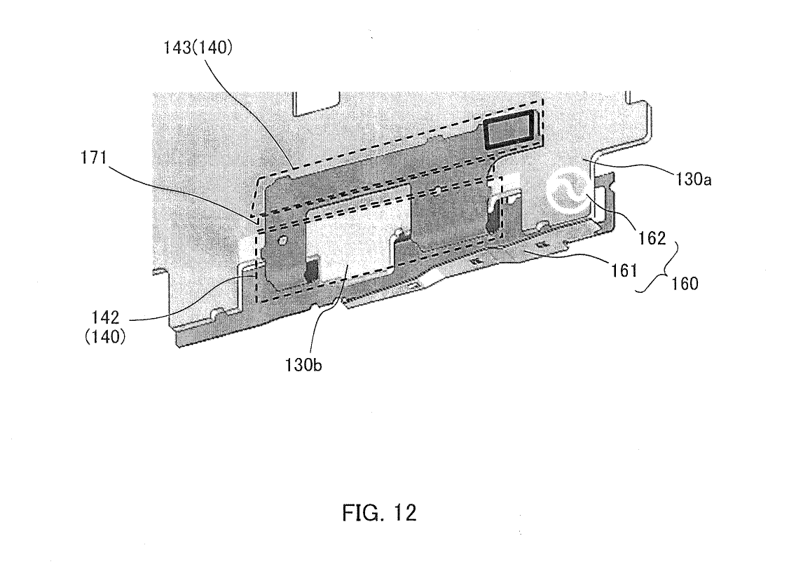

FIG. 12 is a perspective view illustrating a configuration of first isolation circuit 171 and the GND of circuit board 130.

As illustrated in FIG. 12, input part wiring pattern 140, which is formed on a flexible board, is bent along the lower end of circuit board 130. In this case, orthogonal wiring portion 142 is placed so as not to overlap with circuit board GND portion 130b.

On the other hand, first isolation circuit 171 is placed between orthogonal wiring portion 142 and horizontal wiring portion 143 and isolates the wiring in a high frequency manner.

First isolation circuit 171 is configured to be placed at a position in such a way orthogonal wiring portion 142 and orthogonal horizontal wiring portion 143 do not overlap each other when input part wiring pattern 140 is bent and incorporated. That is, first isolation circuit 171 is placed so as to not to overlap with bent orthogonal wiring portion 142.

In this way, mobile radio apparatus 100 includes first isolation circuit 171 installed between orthogonal wiring portion 142 and horizontal wiring portion 143 and does not cause overlapping between orthogonal wiring portion 142 and circuit board GND portion 130b. Therefore, the influence on the antenna performance can further be reduced by separating a high frequency current between orthogonal wiring portions 142 and horizontal wiring portions 143.

Moreover, coupling between orthogonal wiring portion 142 and horizontal wiring portion 143 in a high frequency manner can be reduced. This can improve a high frequency isolation effect achieved by first isolation circuit 171.

Moreover, coupling between orthogonal wiring portion 142 and circuit board 130 in a high frequency manner can be reduced. This can improve a high frequency isolation effect achieved by first isolation circuit 171.

As explained in detail above, mobile radio apparatus 100 according to the present embodiment includes circuit board 130, input part wiring pattern 140 formed on a flexible board which is different from circuit board 130, and antenna element 160 including electric supply section 162 connected to board end 130a of circuit board 130.

Conductor portion 161 of antenna element 160, key surface portion 141 bent along board end portion 130a, orthogonal wiring portion 142, horizontal wiring portion 143, connector 150 placed near electric supply section 162 on horizontal wiring portion 143 are placed in this order from lower end housing portion 110a in the upward longitudinal direction of housing 110.

Orthogonal wiring portion 142 is wired orthogonally with respect to antenna element 160. First isolation circuit 171 is installed between orthogonal wiring portion 142 and horizontal wiring portion 143, and isolates orthogonal wiring portion 142 and orthogonal horizontal wiring portion 143 from each other in a high frequency manner. Horizontal wiring portion 143 is connected to circuit board 130 through connector 150 placed near electric supply section 162.

The following effects can be achieved by the above configuration.

(1) The wiring of input part wiring pattern 140 close to antenna element 160 is placed orthogonally with respect to antenna element 160 (orthogonal placement of orthogonal wiring portion 142 and antenna element 160). This configuration can reduce the influence of input part wiring pattern 140 placed closely to antenna element 160.

Moreover, horizontal wiring portion 143 is wired in the horizontal direction at a position of overlapping with circuit board GND portion 130b, and the wiring lines are brought together at the end of horizontal wiring portion 143. Then, horizontal wiring portion 143 is connected to circuit board 130 through connector 150. This configuration can increase the implementation space of circuit board 130.

In particular, connector 150 is placed near electric supply section 162, which makes it possible to cause a current flowing through horizontal wiring portion 143 to have the same phase as a current through circuit board GND portion 130b and thus to achieve a high antenna performance.

(2) First isolation circuit 170 is installed between orthogonal wiring portion 142 and horizontal wiring portion 143, and isolates orthogonal wiring portion 142 and orthogonal horizontal wiring portion 143 from each other in a high frequency manner. Moreover, circuit board GND portion 130b is placed on circuit board 130 except for a portion overlapping with orthogonal wiring portion 142 in planar view. Alternatively, circuit board 130 is placed so as not to overlap with orthogonal wiring portion 142.

The effects in (1) can further be improved by separating a high frequency current between orthogonal wiring portion 142 and horizontal wiring portion 143.

Moreover, orthogonal wiring portion 142 is prevented from overlapping with circuit board GND portion 130b, which in turn prevents coupling between orthogonal wiring portion 142 and circuit board GND portion 130b through the hoard. The high frequency isolation effect achieved by first isolation circuit 171 can be thereby further improved.

(3) In the case of providing the plurality of key portions 101a to 101e, signal lines having the same potential, such as GND lines on diaphragms on key surface portion 141, are connected on key surface portion 141 through second isolation circuits 172 placed between the plurality of key portions 101a to 101c.

The signal lines having the same potential can be connected on key surface portion 141, which in turn makes it possible to reduce the number of wiring lines of orthogonal wiring portion 142 and reduce the physical width of orthogonal wiring portion 142. As a result, it is made possible to further reduce the influence on the antenna performance and also to reduce the size of the apparatus.

In addition, placing second isolation circuits 172 among key portions 101a to 101c makes the wiring on key surface portion 141 look as if the wiring is not connected in the horizontal direction. Accordingly, the wiring lines can be reduced while the effects described in (1) are maintained with the orthogonal wiring design.

(4) Orthogonal wiring portion 142 is bent in such a way that wiring lines do not overlap each other. Moreover, components (for example, LED 102) of key surface portion 141 are connected to orthogonal wiring portion 142 through third isolation circuit 173.

Accordingly, it is possible to avoid increases in the influence on the performance due to closely positioned antenna element 160, which otherwise occur due to capacitive coupling of overlapping wiring lines causing a reduction in the isolation effect achieved by second isolation circuit 172.

Moreover, the components placed on key surface portion 141 are separated from orthogonal wiring portion 142 in a high frequency manner by third isolation circuit 173 and are thereby configured as floating conductors. Accordingly, the influence on the antenna performance due to the conductors closely placed to antenna element 160 can be reduced.

### Embodiment 2

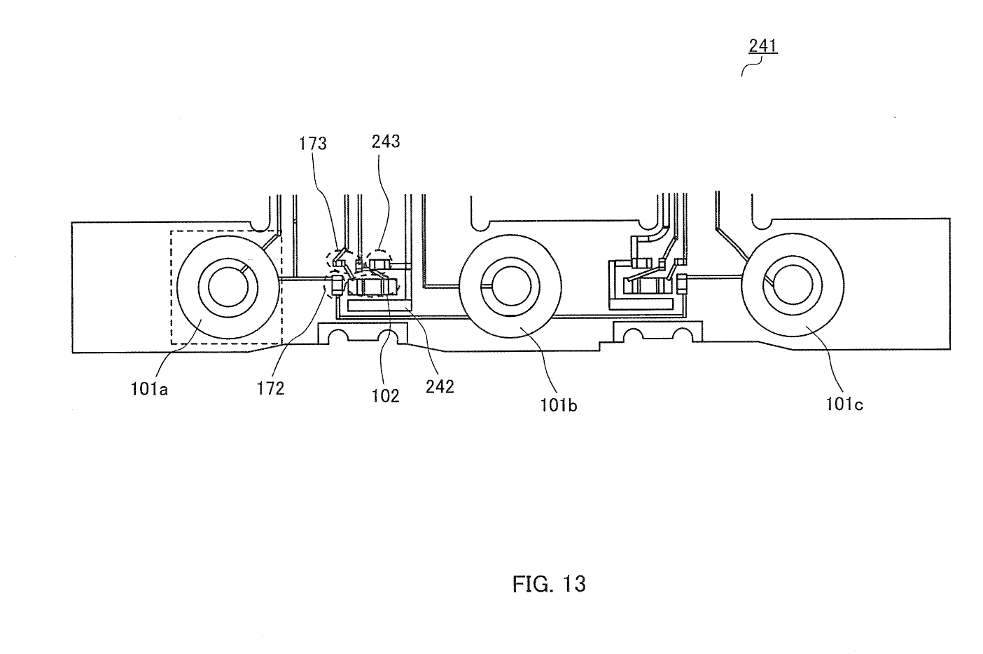

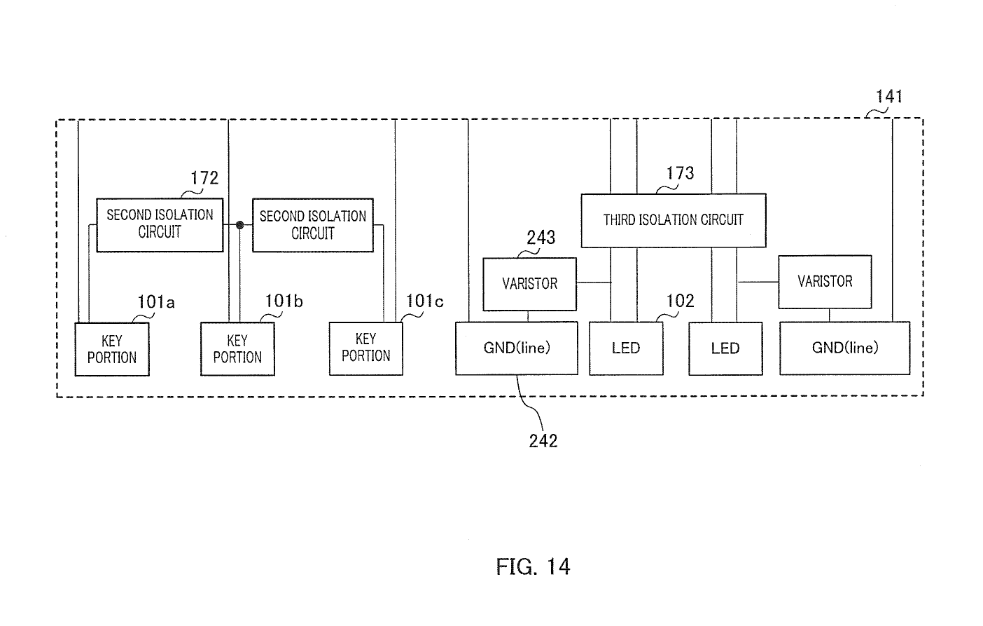

FIG. 13 is a top view illustrating key surface portion 241 of an input part wiring pattern of a mobile radio apparatus according to Embodiment 2 of the present invention. FIG. 14 is a block diagram illustrating a configuration of key surface portion 241. In the explanation of the present embodiment, the same reference numerals are given to the same components as those illustrated in FIGS. 5 and 7, and any duplicate explanation of the components will be omitted.

As illustrated in FIGS. 13 and 14, key surface portion 241 includes key portions 101a to 101c, LEDs 102, second isolation circuits 172 installed between the signal lines having the same potential among key portions 101a to 101c, third isolation circuit 173 installed between LEDs 102 and orthogonal wiring portion 142, GND patterns 242, and varistors 243 each connected between LED 102 and GND pattern 242 and configured to protect LED 102 from a high voltage.

Key surface portion 141 connects the signal lines having the same potential among key portions 101a to 101c on key surface portion 141 through second isolation circuits 172.

LEDs 102 each serving as an example of a component of key surface portion 141 is connected to orthogonal wiring portion 142 through third isolation circuit 173.

LEDs 102 are connected to GND patterns 242 through varistors 243, respectively.

In this embodiment, the signal lines having the same potential can be connected together on key surface portion 241, which in turn reduces the number of wiring lines of orthogonal wiring portion 142 as described above. Thus, the physical width of orthogonal wiring portion 142 can be reduced, which makes it possible to further reduce the influence on the antenna performance and also the size of the apparatus.

Moreover, according to the present embodiment, placing second isolation circuits 172 among key portions 101a to 101c makes the wiring on key surface portion 241 look as if the wiring is not connected in the horizontal direction. Accordingly, the wiring lines can be reduced while the configuration of the orthogonal wiring design is maintained.

Moreover, the components placed on key surface portion 241 (in this case, LEDs 102) are separated in a high frequency manner by third isolation circuit 173 and are thereby configured as floating conductors. Thus, the influence on the antenna performance due to the conductors placed closely to antenna element 160 can be reduced.

Moreover, connecting LEDs 102 to GND patterns 242 through varistors 243, respectively, can prevent static electricity from damaging LEDs 102.

The above explanation is provided as an example of preferred embodiments of the present invention and the scope of the invention is by no means limited to this explanation.

The present invention can be applied to any mobile radio apparatus including an antenna element connected to a circuit board and a microphone placed near the antenna element. The present invention is obviously applicable to a mobile radio apparatus having a bar structure, and is also applicable to, for example, a mobile telephone, a PHS (Personal Handy-Phone System), a mobile information terminal such as a PDA (Personal Digital Assistant), and an information processing apparatus such as a notebook size personal computer.

Moreover, the electric supply section of each of the above-described embodiments is schematically illustrated on the drawings. In reality, the circuit board and the antenna element are connected by, for example, an elastic metal or a pin.

In the above-described embodiments, the term “mobile radio apparatus” is used for convenience of the explanation. However, terms such as “mobile radio” and “radio apparatus” may obviously be used.

Moreover, the housing, antenna element, flexible board the connector included in each of the above-described mobile radio apparatuses are by no means limited to the type, quantity, and connection method described in the above-described embodiments.

The disclosure of Japanese Patent Application No. 2011-108203, filed on May 13, 2011, including the specification, drawings and abstract, is incorporated herein by reference in its entirety.

### INDUSTRIAL APPLICABILITY

The present invention can provide a mobile radio apparatus including an antenna element at a lower end housing portion and being capable of reducing the influence of a closely placed input part on the antenna performance and also capable of achieving an increase in the implementation volume of the mobile radio apparatus. The present invention is suitable for use in mobile radio apparatuses such as mobile telephones having a bar structure.

### REFERENCE SIGNS LIST

100 Mobile radio apparatus
101 Input part
101a to 101c Key portions
102 LED
110 Housing
110a Lower end housing portion
130 Circuit board
130a Board end portion
140 Input part wiring pattern
141, 241 Key surface portion
142 Orthogonal wiring portion
143 Horizontal wiring portion
150 Connector
160 Antenna element
161 Conductor portion
162 Electric supply section
171 First isolation circuit
172 Second isolation circuit
173 Third isolation circuit
242 GND pattern
243 Varistor

1. A mobile radio apparatus comprising:
a circuit board;
an input part wiring pattern that is formed on a flexible board different from the circuit board; and
an antenna element that includes an electric supply section connected to an end of the circuit board, wherein
the input part wiring pattern comprises:
a key surface portion that includes one or more key portions;
an orthogonal wiring portion that is wired from the key surface portion which is made orthogonally to the antenna element;
a horizontal wiring portion that is connected to the orthogonal wiring portion and that is wired horizontally with respect to the antenna element; and
a connector that is placed at the horizontal wiring portion near the electric supply section and that connects the horizontal wiring portion and the circuit board.

2. The mobile radio apparatus according to claim 1, wherein the connector is provided on the input part wiring pattern in which a board current flowing through the circuit board and a wiring pattern current flowing through the horizontal wiring portion have the same phase.

3. The mobile radio apparatus according to claim 1, further comprising a first isolation circuit that is installed between the orthogonal wiring portion and the horizontal wiring portion and that isolates the orthogonal wiring portion and the orthogonal horizontal wiring portion from each other in a high frequency manner.

4. The mobile radio apparatus according to claim 1, wherein:
the orthogonal wiring portion is bent along the end of the circuit board; and
the first isolation circuit is placed at a position not overlapping with the bent orthogonal wiring portion.

5. The mobile radio apparatus according to claim 1, wherein:
the circuit board comprises a ground pattern; and
the orthogonal wiring portion is bent along the end of the circuit board, and the ground pattern is not placed in the circuit board that overlaps with the orthogonal wiring portion.

6. The mobile radio apparatus according to claim 1, wherein the orthogonal wiring portion is bent along the end of the circuit board in such a way that different wiring lines do not overlap each other.

7. The mobile radio apparatus according to claim 1, wherein
the key surface portion comprises:
signal lines that connect the key portions at the same potential; and
a second isolation circuit that is installed between the signal lines and that isolates the signal lines from each other in a high frequency manner in the horizontal direction.

8. The mobile radio apparatus according to claim 1, wherein
the key surface portion comprises:
an electronic part that includes an LED; and
a third isolation circuit that is installed between signal lines connecting the electronic part and the orthogonal wiring portion and that separates the electronic part from the orthogonal wiring portion in a high frequency manner.

9. The mobile radio apparatus according to claim 8, further comprising a protection element that protects the electronic part from a high voltage.
